(19) United States
(12) Patent Application Publication
(10) Pub. No.: US 2018/0326818 A1
(43) Pub. Date: Nov. 15, 2018

(54) METHOD OF CONTROLLING AIR FRESHENER DEVICE FOR PASSENGER COMPARTMENT OF VEHICLE

(71) Applicant: LG Electronics Inc., Seoul (KR)

(72) Inventors: Seongho HONG, Seoul (KR); Naehyun PARK, Seoul (KR); Hyounjeong SHIN, Seoul (KR)

(21) Appl. No.: 15/776,464

(22) PCT Filed: Jul. 28, 2016
(86) PCT No.: PCT/KR2016/008278

§ 371 Date: May 16, 2018

(30) Foreign Application Priority Data
Nov. 16, 2015 (KR) 10-2015-0160622

(51) Int. Cl. B60H 3/00; B60H 1/00

(52) U.S. Cl. CPC B60H 3/0035; B60H 2003/0064; B60H 1/008; B60H 1/00742

(57) ABSTRACT

A method of controlling an air freshener device for a passenger compartment of a vehicle is disclosed. The method has an effect of creating various environments in the passenger compartment, using anion perfume modules, which are coupled to air ducts so as to communicate therewith or are mounted to air discharge ports of a vehicular air cleaning device, and which generate perfume having negative polarity (−) characteristics using electric current applied thereto so that the perfume is mixed with purified air discharged from the air discharge ports and is directed toward a passenger, having positive polarity (+) characteristics, in the passenger compartment.

### TECHNICAL FIELD

The present invention relates to a method of controlling an air freshener device for a passenger compartment of a vehicle, and more particularly, to a method of controlling an air freshener device for a passenger compartment of a vehicle, which is capable of creating various atmospheric environments in the passenger compartment on the basis of the current atmospheric environment in the passenger compartment and the driver's emotional state.

### BACKGROUND ART

In general, a car is a means of transportation designed to carry passengers seated comfortably in seats. So far, vehicle technology development has been focused on the running of vehicles. Recently, research on technology related to the convenience and health of passengers in vehicles is being carried out.

FIG. 1 is a view illustrating an exemplary conventional passenger compartment of a vehicle.

The interior of the vehicle 1 (hereinafter, referred to as a “passenger compartment”) is divided into a driver's seat section D, which is intended to be occupied by a driver, a front passenger's seat section A, which is provided next to the driver's seat, and a rear section C, which is provided behind the driver's seat and the front passenger's seat.

Typically, as illustrated in FIG. 1, for the improvement of air quality or the atmosphere in the passenger compartment, the owner of the vehicle needs to additionally purchase an air freshener 10 and place the air freshener 10 in a region through which conditioned air, generated from a vehicle air conditioning device, is discharged, or onto an instrument panel, which is provided at a front portion in the passenger compartment. However, a fragrant substance is merely ejected from the air freshener 10, and is uniformly diffused toward the driver's seat section D, the front passenger's seat section A and the rear section C in the passenger compartment. Further, because only one fragrance is released, there is a problem in that it is difficult to adapt the fragrance for various environments to suit the driver or the passenger in the passenger compartment.

### DISCLOSURE OF INVENTION

### Technical Problem

The present invention is devised to solve the above problems, and it is an object of the present invention to provide a method of controlling an air freshener device for a passenger compartment of a vehicle, which is capable of generating anionized perfume having negative polarity (−) characteristics using an anion perfume module and spraying the anionized perfume toward the passenger (human body), having positive polarity (+) characteristics, by means of an air duct of the vehicle, thereby improving the atmospheric environment in the passenger compartment and creating a heterogeneous pleasant environment in the passenger compartment that suits the passengers' emotional state and state of health.

### Solution to Problem

In accordance with an aspect of the present invention, the above and other objects can be accomplished by the provision of a method of controlling an air freshener device for a passenger compartment of a vehicle, including first determining a physical state of a driver or a state of air quality in the passenger compartment, first spraying at least one of a plurality of perfume capsules, selected based on a determination result of the first determining, into the passenger compartment, second determining the physical state of the driver or the state of air quality in the passenger compartment continuously after the first spraying or during the first spraying, and upon determining that the physical state of the driver or the state of air quality in the passenger compartment has been changed in the second determining, second spraying at least one of the plurality of perfume capsules, newly selected, including the perfume capsule which is currently being sprayed.

The physical state of the driver, to be determined in the first determining and the second determining, may be classified into a drowsy driving state (hereinafter, referred to as a “first state”), a visually distracted driving state (hereinafter, referred to as a “second state”), and a stressed state (hereinafter, referred to as a “third state”).

The first determining and the second determining may include determining the physical state of the driver based on information about the driver, acquired by sensing the driver using a biometric information acquisition unit mounted to the vehicle.

The plurality of perfume capsules may include a first capsule having a predetermined stimulating ingredient so as to help the driver overcome the first state or the second state, and a second capsule having a predetermined stress-relieving ingredient so as to help the driver overcome the third state.

Upon determining that the physical state of the driver is the first state or the second state in the first determining or the second determining, the first spraying and the second spraying may include selecting and spraying the first capsule.

Upon determining that the physical state of the driver is the third state in the first determining or the second determining, the first spraying and the second spraying may include selecting and spraying the second capsule.

Upon determining that the physical state of the driver is a combination of the first state and the third state or a combination of the second state and the third state in the first determining or the second determining, the first spraying and the second spraying may include selecting and spraying the first capsule and the second capsule at the same time.

The state of air quality in the passenger compartment, to be determined in the first determining and the second determining, may be classified into a contaminated state (hereinafter, referred to as a “first air quality state”), and a humid state (hereinafter, referred to as a “second air quality state”).

The first determining and the second determining may include determining the state of air quality in the passenger compartment based on a sensing value from an air quality sensor mounted to an interior portion and an exterior portion of the vehicle.

The first air quality state may be classified into a state in which a contamination source is outside the passenger compartment (hereinafter, referred to as an “externally contaminated state”), and a state in which the contamination source is inside the passenger compartment (hereinafter, referred to as an “internally contaminated state”).

The plurality of perfume capsules may include a third capsule having a predetermined medicinal ingredient serving as a health supplement for the driver, and a fourth capsule having a predetermined purifying ingredient for improving the state of air quality in the passenger compartment.

Upon determining that the state of air quality in the passenger compartment is the first air quality state in the first determining or the second determining, the first spraying and the second spraying may include selecting and spraying the third capsule.

Upon determining that the state of air quality in the passenger compartment is the second air quality state in the first determining or the second determining, the first spraying and the second spraying may include selecting and spraying the fourth capsule.

Upon determining that the state of air quality in the passenger compartment is a combination of the first air quality state and the second air quality state in the first determining or the second determining, the first spraying and the second spraying may include selecting and spraying the third capsule and the fourth capsule at the same time.

The method may further include operating an air conditioning device, provided in the vehicle, in an external air mode for allowing inflow of external air after determining that the physical state of the driver is the first state in the first determining until determining that the physical state of the driver is not the first state any longer in the second determining.

The method may further include operating an air cleaning device, provided in the vehicle, in a contamination removal mode for purifying contaminated air in the passenger compartment.

The method may further include operating an air conditioning device, provided in the vehicle, in an external air mode for allowing an inflow of external air and in a dehumidification mode for dehumidifying air in the passenger compartment after determining that the state of air quality in the passenger compartment is the second air quality state in the first determining until determining that the state of air quality in the passenger compartment is not the second air quality state any longer in the second determining.

The method may further include, upon determining that the physical state of the driver is not any one of the first through third states or that the state of air quality in the passenger compartment is not any one of the first and second air quality states in the second determining, operating an air cleaning device, provided in the vehicle, in a deodorization mode for removing a scent of the first capsule and a scent of the second capsule, sprayed into the passenger compartment, and operating an air conditioning device, provided in the vehicle, in an internal air mode for circulating internal air in the passenger compartment.

The first spraying and the second spraying may include selecting at least any one of the plurality of perfume capsules through insertion of injection needles into the perfume capsules, which are rotated by a perfume tray, and application of electric current to the injection needles.

The first spraying and the second spraying may include selecting at least any one of the plurality of perfume capsules through application of electric current to at least any one of injection needles, which are already inserted into the plurality of perfume capsules disposed on a fixed perfume tray.

### Advantageous Effects of Invention

A method of controlling an air freshener device for a passenger compartment of a vehicle in accordance with a preferred embodiment of the present invention has the effects of being capable of improving driving stability by selecting, from among a plurality of perfume capsules, a suitable one, which promotes safe driving according to a driver's or passenger's emotional state and the state of air quality in the passenger compartment, and creating a pleasant environment in the passenger compartment using the selected perfume capsule.

### BRIEF DESCRIPTION OF DRAWINGS

FIG. 1 is a view illustrating an exemplary conventional passenger compartment of a vehicle;

FIGS. 2 and 3 are perspective views illustrating structures of various indoor air freshener devices, which are controlled by a method of controlling an air freshener device for a passenger compartment of a vehicle in accordance with the present invention;

FIG. 4 is a perspective view illustrating a first embodiment of an anion perfume module of the constitutional components of the air freshener device for a passenger compartment of a vehicle;

FIG. 5 is an exploded perspective view of FIG. 4;

FIG. 6 is a perspective view illustrating a perfume capsule of the constitutional components shown in FIG. 4;

FIG. 7 is a partially cut away perspective view illustrating the perfume capsule of the constitutional components shown in FIG. 4;

FIG. 8 is a sectional view illustrating the operational state of the perfume capsule of the constitutional components shown in FIG. 4;

FIGS. 9a and 9b are sectional views illustrating the operational state of an electric current application unit of the constitutional components of a first embodiment and a second embodiment of the anion perfume module;

FIG. 10 is a plan view illustrating the state in which a case cover is removed from the constitution of a vehicular air cleaning device mounted inside a vehicle;

FIG. 11 is a block diagram illustrating the process of determining a drowsy driving state or a sleepiness level in accordance with one embodiment disclosed in the specification;

FIG. 12 is a view illustrating a sleepiness trend line of the driver in accordance with one embodiment disclosed in the specification; and

FIGS. 13a through 13d are control flowcharts illustrating a preferred embodiment of the method of controlling the air freshener device for a passenger compartment of a vehicle in accordance with the present invention.

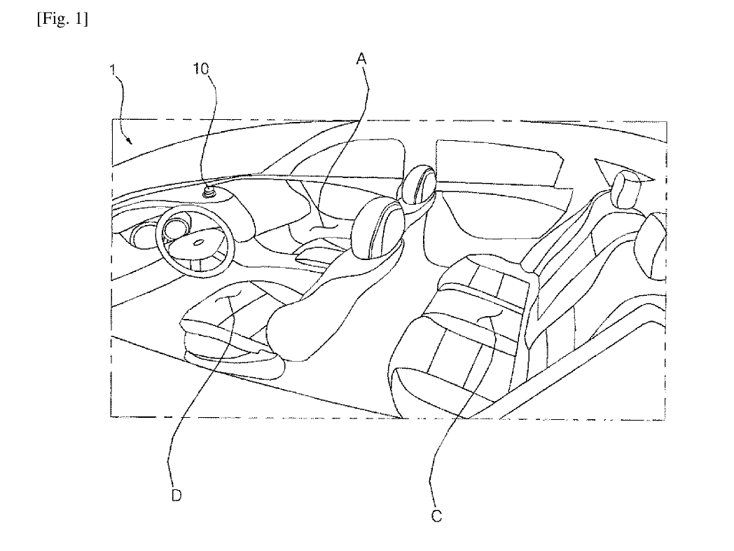

### BEST MODE FOR CARRYING OUT THE INVENTION

Hereinafter, embodiments of a method of controlling an air freshener device for a passenger compartment of a vehicle in accordance with the present invention will be described in detail with reference to the accompanying drawings.

Before explaining particular embodiments of the method of controlling an air freshener device for a passenger compartment of a vehicle in accordance with the present invention, the concrete constitution of various embodiments of the “air freshener device for a passenger compartment of a vehicle”, to which the control method of the present invention is applied, will be first explained.

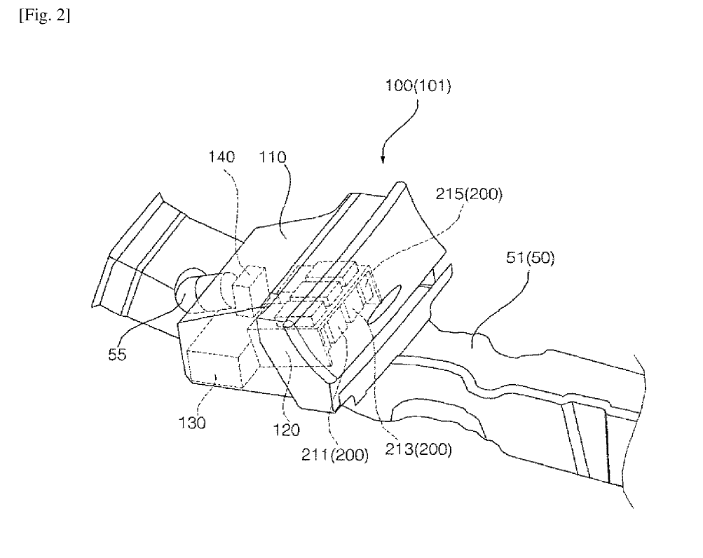

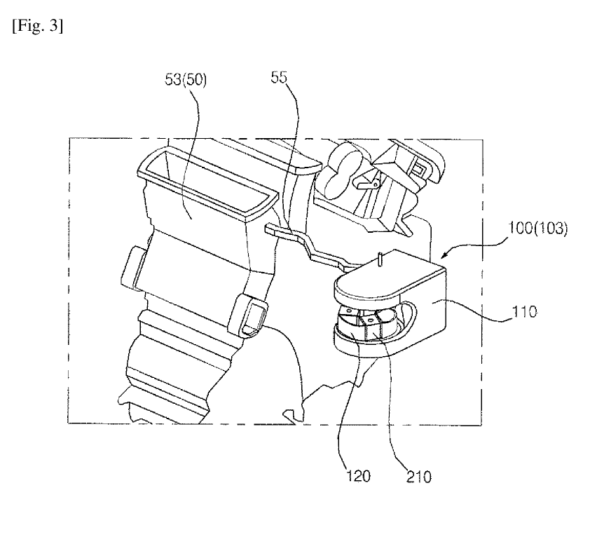

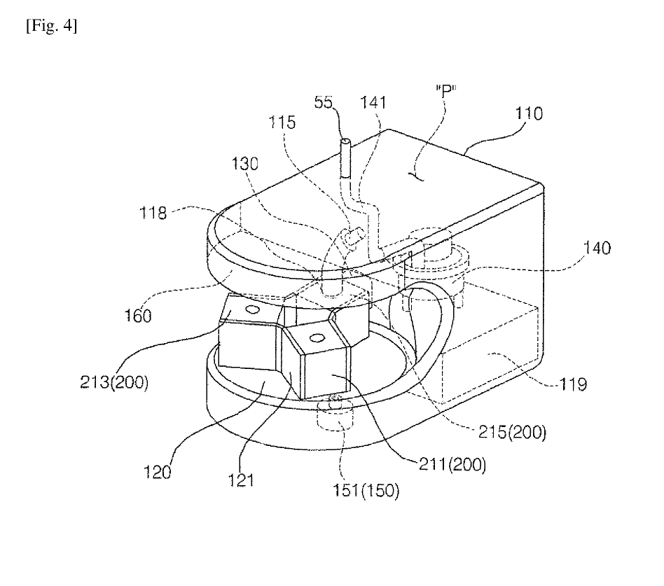

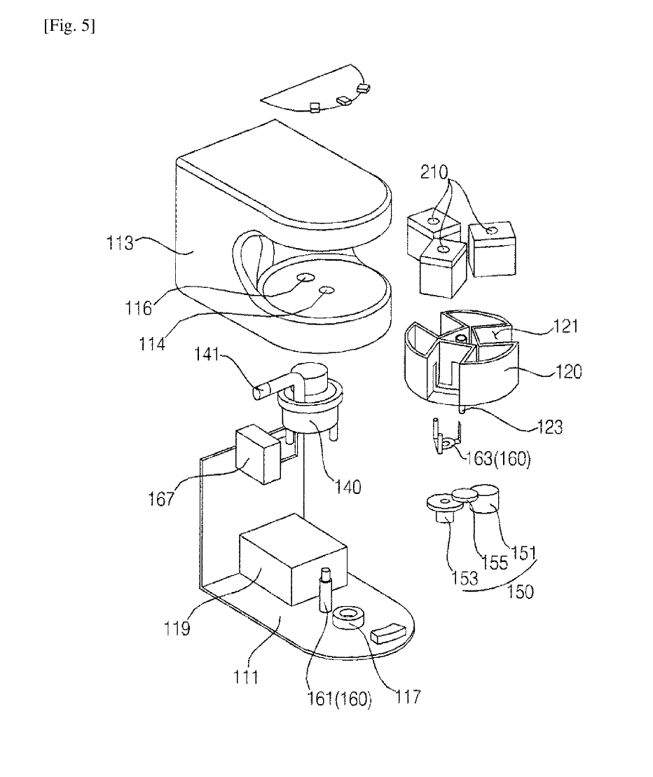

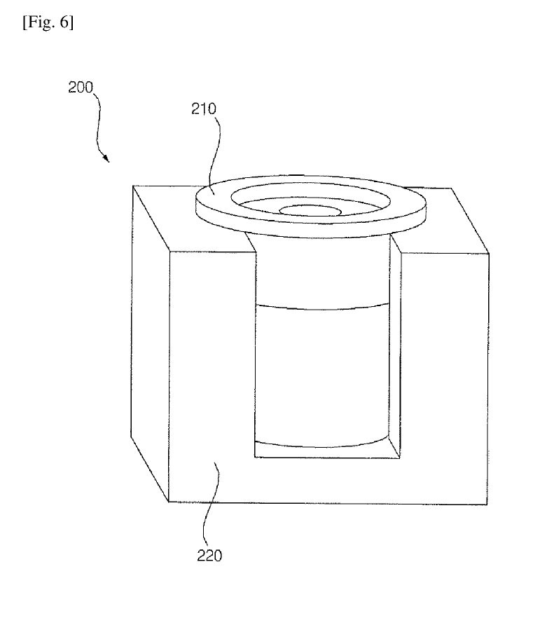

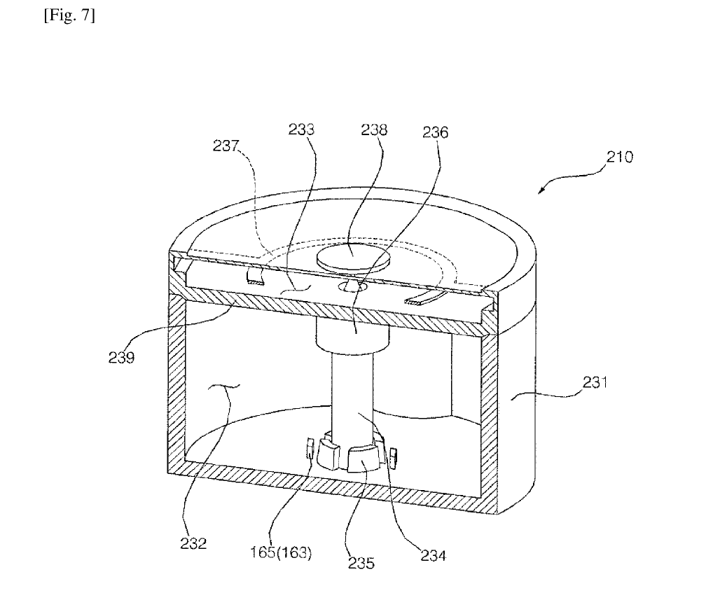

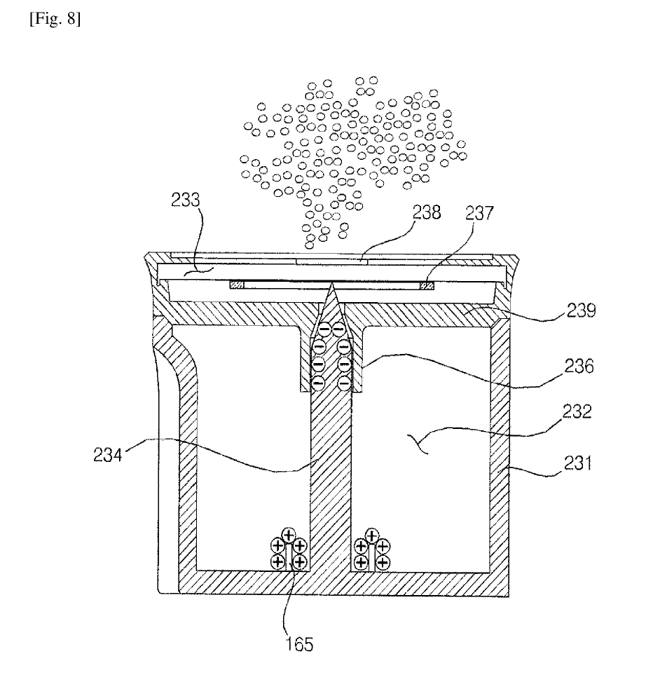

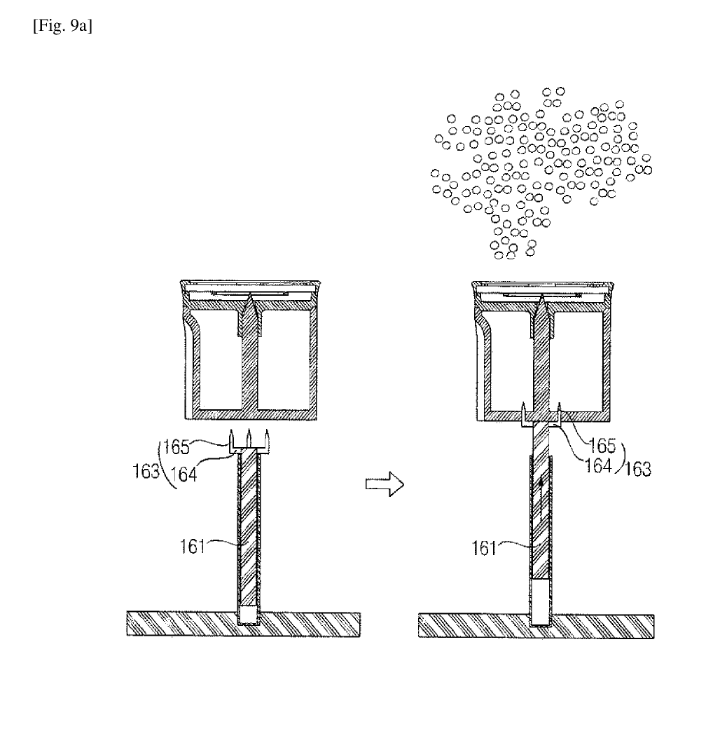

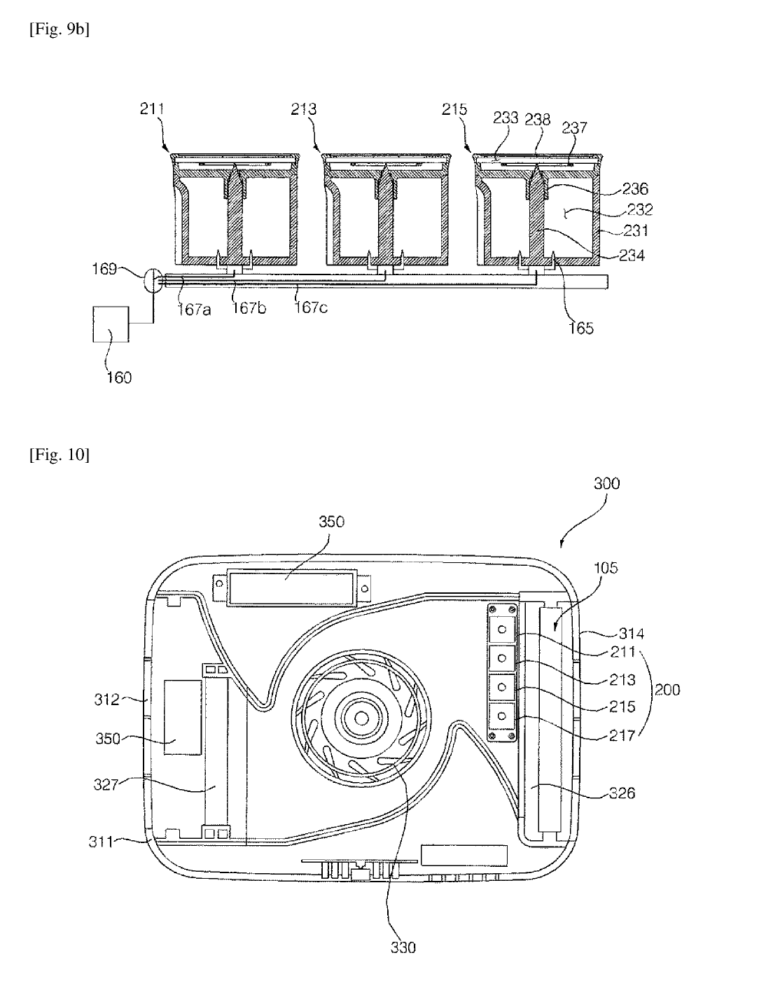

FIGS. 2 and 3 are perspective views illustrating various embodiments of an air freshener device for a passenger compartment of a vehicle, FIG. 4 is a perspective view illustrating a first embodiment of an anion perfume module of the constitutional components of the air freshener device for a passenger compartment of a vehicle, FIG. 5 is an exploded perspective view of FIG. 4, FIG. 6 is a perspective view illustrating a perfume capsule of the constitutional components shown in FIG. 4, FIG. 7 is a partially cut away perspective view illustrating the perfume capsule of the constitutional components shown in FIG. 4, FIG. 8 is a sectional view illustrating the operational state of the perfume capsule of the constitutional components shown in FIG. 4, and FIGS. 9a and 9b are sectional views illustrating the operational state of an electric current application unit of the constitutional components of a first embodiment and a second embodiment of the anion perfume module in the air freshener device for a passenger compartment of a vehicle.

As illustrated in FIGS. 2 and 3, a first embodiment of the air freshener device for a passenger compartment of a vehicle includes air ducts 50, which are disposed at a plurality of positions in the passenger compartment so as to supply conditioned air to the passenger compartment, and anion perfume modules 100, which are coupled to the air ducts 50 so as to communicate therewith and which generate perfume having negative polarity (−) characteristics using electric current applied thereto so that the perfume is mixed with the air discharged from the air ducts 50 and is directed toward a passenger (i.e. a human body having positive polarity (+) characteristics) in the passenger compartment.

Here, the perfume having negative polarity (−) characteristics may be limited to a gaseous material having a specific scent (smell) that stimulates the human's sense of smell. However, as described above, so long as it is a gaseous material having negative polarity (−) characteristics, any material for any purpose may be included in the embodiment of the air freshener device for a passenger compartment of a vehicle.

As an example, the perfume may be a material that emits a specific scent, or may be a skin care material that is applied to the human's skin. As such, the perfume in the embodiment may be defined as a functional material.

In general, the human body has positive polarity (+) characteristics, and thus a gaseous material having negative polarity (−) characteristics is readily diffused toward the human body. The gaseous material may be a moisture ion material, which is applied to externally exposed skin, such as, for example, the face. When the perfume is embodied as a moisture ion material, the moisture ion material can be applied to the skin of the passenger in the passenger compartment. Accordingly, even when the air in the passenger compartment is dry, the passenger's skin is naturally kept moist and glossy without any other special treatment while the passenger is on board.

The air duct 50 is a component that forms a flow passage, through which conditioned air delivered from the vehicular air conditioning device (not illustrated) is supplied to the passenger compartment. The air duct 50, as illustrated in FIGS. 2 and 3, may include a main duct body 53, which directly receives conditioned air from the air conditioning device, and a rear duct 51, which delivers the conditioned air from the main duct body 53 to a rear portion in the passenger compartment.

In addition, the air duct 50 may further include side ducts (not illustrated), which are bifurcated from the main duct body 53 to the left and right inside the instrument panel, and foot ducts (not illustrated), through which the conditioned air is discharged toward the driver's feet or the front passenger's feet.

The air duct 50, to which the anion perfume module 100 is coupled, may be coupled so as to communicate with at least any one of the main duct body 53, which is disposed at a lower portion inside the instrument panel in the passenger compartment so as to directly receive conditioned air, and the rear duct 51, which extends from the main duct body 53 toward the rear seats in the passenger compartment.

As described above, in the first embodiment of the air freshener device for a passenger compartment of a vehicle, the anion perfume module 100 is arranged so as to communicate with the main duct body 53 and the rear duct 51, but the embodiment is not limited to this arrangement.

The anion perfume module 100, as illustrated in FIGS. 2 through 4, may include a perfume housing unit 110, which is arranged so as to communicate with the air duct 50 of the vehicular air conditioning device and has a perfume-containing space P for containing the perfume therein, a plurality of perfume capsules 200, which are arranged inside or outside the perfume housing unit 110 and discharge perfume, which is generated from at least any one perfume capsule selected according to the driver's state or the user's intention, to the perfume-containing space P, a perfume tray 120, to which the perfume capsules 200 are secured, and an electric current application unit 160, which applies electric current to any one of the perfume capsules 211, 213 and 215, which is selected according to the driver's state or the user's intention.

Hereinafter, the embodiment in which the anion perfume module 100 is mounted to the main duct body 53, the perfume capsules are disposed outside the perfume housing unit 110, and a plurality of perfume blocks 210 is rotated by the perfume tray 120, which is rotatably mounted, will be referred to as an “anion perfume module 103 in accordance with the first embodiment”, and the embodiment in which the anion perfume module 100 is mounted to the rear duct 51, the perfume capsules 200 are disposed inside the perfume housing unit 110, and the perfume tray 120 is fixed will be referred to as an “anion perfume module 101 in accordance with the second embodiment”, so that they will be explained as distinguished from each other.

The anion perfume module 103 in accordance with the first embodiment and the anion perfume module 101 in accordance with the second embodiment include a plurality of perfume capsules 200 in common.

In particular, each of the perfume capsules 200, as illustrated in FIGS. 6 and 7, may include a fixing case 220, which is coupled to the perfume tray 120, and a perfume block 210, which is fitted into the fixing case 220, has a charging space 232, in which a perfume solid, which is a material for generating perfume, is charged, and a collection space 233, in which perfume gas gasified in the charging space 232 is collected, and generates perfume through the operation of gasifying the perfume solid.

The perfume solid, which is charged in the charging space 232, may be formed of a gel-type material, and may be a material that is naturally gasified with the passage of time. The perfume solid may also be limited to a material that ionizes depending on the polarity when electric current is applied thereto.

The electric current application unit 160 may include a power supply (not illustrated), which generates high voltage, and an injection needle 163, which applies electric current to the perfume capsule using the voltage generated from the power supply through the operation of being inserted into the perfume block 210 from outside the perfume capsule, or applies electric current to the perfume capsule using the voltage generated from the power supply in the state in which the injection needle is already inserted into the perfume capsule.

The anion perfume module 103 in accordance with the first embodiment, as illustrated in FIG. 9a, may be constituted such that electric current is applied through the operation of inserting the injection needle 163 into the perfume block 210 from outside the perfume capsule. The anion perfume module 101 in accordance with the second embodiment, as illustrated in FIG. 9b, may be constituted such that electric current is applied in the state in which the injection needle 163 is already inserted into the perfume capsule.

First, the concrete constitution of the anion perfume module 103 in accordance with the first embodiment will be described hereinafter.

In the anion perfume module 103 in accordance with the first embodiment, the electric current application unit 160, as illustrated in FIGS. 5 and 9a, may further include a needle driving unit 161 for moving the injection needle 163 so as to be inserted into the perfume block 210 from outside the perfume capsule.

The injection needle 163 is coupled to the front end portion of the needle driving unit 161. Here, the needle driving unit 161, as illustrated in FIG. 9a, may be embodied as a solenoid, which serves to insert the injection needle 163 into the perfume block 210 or separate the injection needle 163 from the perfume block 210. As such, by being secured to the front end of the solenoid, which is exposed outside, the injection needle 163 is moved cooperatively with the solenoid, which is electrically driven for linear movement.

The injection needle 163 may include a coupling portion 164, which is coupled to the solenoid, and a needle portion 165, which is inserted into or separated from the solid in the perfume block 210.

The coupling portion 164 may be formed to have a circular plate shape having a fixing hole (not denoted by a reference numeral) formed in the center portion thereof, into which the front end portion of the solenoid is inserted, and the needle portion 165 may be formed to have a needle shape, which protrudes toward the perfume block 210 respectively from three points on the circumference of the circular plate-shaped coupling portion 164.

The perfume block 210, as illustrated in FIGS. 6 and 7, includes a block case 231, which is formed in a cylindrical shape and has the above-described charging space 232 and the collection space 233, and a capillary column 234, which extends in the vertical direction in the middle of the charging space 232 in the block case 231, anionizes the perfume solid, which is cationized in the charging space 232 by the electric current applied thereto by the electric current application unit 160, and delivers the anionized perfume solid to the collection space 233. The capillary column 234 may be formed of a porous material, and particularly, may be a carbon rod made of a porous material and having a size in which predetermined capillary pressure is generated.

In other words, if electric current is applied in the state in which the needle portion 165 of the injection needle 163 is inserted into the perfume block 210, as illustrated in FIG. 8, a portion of the perfume solid is anionized by the needle portion 165 of the injection needle 163, because the perfume solid is formed of a gel-type material that can be ionized.

This anionized perfume solid is concentrated on the region around the capillary column 234 by the capillary pressure of the capillary column 234, and the capillary column 234, which is embodied as a carbon rod, is electrified so that the lower end portion of the capillary column 234 has negative polarity (−) characteristics and the upper end portion of the capillary column 234 has positive polarity (+) characteristics.

Here, the anionized perfume solid concentrated around the capillary column 234 is moved from the charging space 232, which is provided around the lower end portion of the capillary column 234, which is electrified as described above, to the collection space 233, which is provided around the upper end portion of the capillary column 234, by the capillary pressure. Subsequently, the anionized perfume solid is gasified in the collection space 233, is delivered to the perfume-containing space P in the perfume housing unit 110 through a docking hole 238, which is open above the collection space 233, and is eventually discharged to the passenger compartment through the above-described air duct 50.

As illustrated in FIG. 7, the needle portion 165 may be provided at the bottom of the perfume block 210, in which the charging space 232 is formed, so as to be inserted into or separated from the charging space 232, and an annular-shaped grounding terminal 237, for electrical connection of the electrified current to earth, may be provided around the upper end portion of the capillary column 234 in the collection space 233 of the perfume block 210.

The grounding terminal 237 serves to regulate a potential difference, generated between the electrified capillary column 234 and the grounding terminal 237, so that an electric field can be formed stably.

A certain current difference is generated between the needle portion 165 and the grounding terminal 237, and this current difference serves as the driving source that moves the anionized perfume solid from the charging space 232 to the collection space 233 in cooperation with the capillary pressure of the capillary column 234.

The perfume tray 120 is rotatably provided, as illustrated in FIGS. 4 and 5. When the user selects any one of the perfume capsules 200 via manipulation of a switch (not illustrated), the selected perfume capsule 200 is rotated cooperatively with the rotation of the perfume tray 120 and is stopped at a predetermined position. Then, the injection needle 163 of the electric current application unit 160, which is positioned below the stop position, is inserted into the lower portion of the perfume block 210, thereby achieving the electrical connection.

The perfume capsule 200 is rotated by the perfume tray 120 outside the perfume housing 110 and is stopped at a predetermined position so that the perfume capsule 200 is electrically connected with the electric current application unit 160 and so that the collection space 233 of the perfume capsule 200 and the perfume-containing space P of the perfume housing unit 110 communicate with each other.

More particularly, in the anion perfume module 103 in accordance with the first embodiment, a plurality of perfume capsules 200 is rotated in the horizontal direction about a vertical rotating shaft 123 by the perfume tray 120. Here, a tray driving unit 150, which generates rotational force for rotating the perfume tray 120, is provided at a position in the perfume-containing space P, which is located below the perfume tray 120, of the perfume housing unit 110.

The tray driving unit 150, as illustrated in FIG. 5, includes a driving motor 151, which rotates about a vertical axis, a transmission gear 155, which rotates in tooth-engagement with a rotating shaft of the driving motor 151, and a driving gear 153, to which the rotating shaft of the perfume tray 120 is secured and which rotates in tooth-engagement with the transmission gear 155.

When the driving motor 151 rotates, the driving gear 153 also rotates via the transmission gear 155, and the rotating shaft of the perfume tray 120, secured to the driving gear 153, rotates simultaneously therewith, thereby rotating the perfume tray 120.

At this time, the driving motor 151 rotates the perfume tray 120 so that the docking hole 238 formed in the perfume block 210 of the selected perfume capsule is aligned with a connection hole 118 formed in the perfume housing unit 110, which is positioned above the perfume capsule. Although not illustrated in the drawings, a sealing component may be added to prevent the perfume from leaking outside when the docking hole 238 and the connection hole 118 are aligned with each other.

When the perfume tray 120 is stopped at the predetermined position described above, the docking hole 238 formed in the top of the perfume block 210 is aligned with the connection hole 118 formed in the perfume housing unit 110, above the perfume block 210, so as to communicate with the perfume-containing space P of the perfume housing unit 110, thereby delivering the anionized perfume from the collection space 233 to the perfume-containing space P.

Here, the top of the perfume block 210 may be embodied as a cover (not denoted by a reference numeral) of a transparent material, and the aforementioned docking hole 238 may be formed in the cover.

The charging space 232 and the collection space 233 may be partitioned from each other by a partition plate 239. The partition plate 239 may have a through-hole (not denoted by a reference numeral) formed therein so as to allow the upper end portion of the capillary column 234 to pass therethrough. The partition plate 239 may be screwed to the outer circumferential surface of the upper end portion of the perfume block 210, and the cover may also be screwed to the outer circumferential surface of the upper end portion of the partition plate 239.

The partition plate 239 may further have a capillary column fixing bush 236 formed integrally therewith near the circumference of the through-hole and extending a predetermined length into the charging space 232. The capillary column fixing bush 236 may protrude downward from the bottom surface of the partition plate 239 so as to be directed toward the charging space 232, and may be formed to have a hollow cylindrical shape. Of course, the through-hole is formed through the capillary column fixing bush 236 so as to extend vertically throughout the length of the capillary column fixing bush 236. The upper end portion of the capillary column 234 passes through and is supported by the capillary column fixing bush 236.

A plurality of support ribs 235 protrudes upwards from the bottom surface of the charging space 232 so as to support the lower end portion of the capillary column 234, and the needle portion 165, which is inserted into the charging space 232, is located near the outer surface of the support ribs 235 and comes into contact with the perfume solid.

Preferably, the power supply provided inside the perfume housing unit 110 may be configured to generate a certain degree of high voltage by which the perfume solid charged in the charging space 232 of the perfume block 210 can be anionized when electric current is applied thereto.

The perfume housing unit 110 includes a lower case 111, which serves as the bottom surface and the rear surface of the perfume-containing space P and in which the electric current application unit 160 and a perfume supply fan 140 are mounted, and an upper case 113, which is coupled to the lower case 111 so as to define the perfume-containing space P by shielding the remaining portion, excluding the bottom surface and the rear surface of the perfume-containing space P, and has a mounting unit (not denoted by a reference numeral), to which the perfume tray 120 and the perfume capsules are mounted outside the upper case 113.

Here, the mounting unit may be formed in a “U” shape having an open front portion, in which the perfume tray 120 and the perfume capsules are accommodated.

In addition, a fan mounting unit 119, to which the perfume supply fan 140 is mounted, is provided at the edge at which the bottom surface and the rear surface of the lower case 111 meet. The power supply is mounted near the fan mounting unit 119. The electric current application unit 160 is securely mounted to a front portion of the bottom surface of the lower case 111, and a rotation support unit 117 for supporting the rotation of the rotating shaft 123 of the perfume tray 120, which is inserted into the rotation support unit 117, is provided in front of the electric current application unit 160.

On the other hand, the anion perfume module 101 in accordance with the second embodiment, as illustrated in FIG. 9b, has the same constitution of the perfume block 210 as the first embodiment, but has a difference in that the needle portion 165 of the injection needle 163 is in the state of already being inserted into the lower portion of each of a plurality of perfume capsules 200.

In addition, a plurality of perfume capsules 200 is electrically connected with the power supply via respective wires 167a, 167b and 167c. A power switch unit 169, which is operated cooperatively with a selection button switch, which will be described later, is interposed between the power supply and each of the wires 167a, 167b and 167c, so that electric current is applied only to the selected perfume capsule 200 via the selected wire.

Therefore, the anion perfume module 101 in accordance with the second embodiment does not need to have the needle driving unit 161 in the first embodiment, and has the aforementioned power switch unit 169 instead of the needle driving unit 161, and the rotating-type perfume tray 120 in the first embodiment may be replaced by a fixed-type perfume tray.

Now, the operation of the perfume block when high voltage is applied thereto will be explained in detail with reference to FIGS. 8 through 9b.

First, the process of selecting any one of a plurality of perfume capsules 200 may be achieved by any one of the user's manipulation (intentional selection using the selection button switch) and selection according to automatic input of the prescribed control signal.

In order for the selection by user's manipulation, a plurality of selection button switches, which the driver or the passenger can manipulate directly, may be provided in the passenger compartment, and the user may carry out the selection by manipulating any one of the selection button switches.

A detailed explanation of selection by automatic input of the control signal will be made later, and the selection by the user's manipulation will now be described.

When the user manipulates the selection button switch, high-voltage current is applied to the selected perfume capsule 200 from the power supply.

At this time, in the case of the anion perfume module 103 in accordance with the first embodiment, as illustrated in FIG. 9a, the perfume tray 120 is rotated, and the perfume capsule 200 desired by the user is positioned above the needle driving unit 161. The needle driving unit 161 moves the needle portion 165 upwards so that the needle portion 165 is inserted into the lower portion of the selected perfume capsule 200, thereby applying a predetermined electric current to the perfume solid.

Meanwhile, in the case of the anion perfume module 101 in accordance with the second embodiment, as illustrated in FIG. 9b, the power switch unit 169 is switched so that electric current is applied only to the perfume capsule selected by the user.

When the predetermined electric current is applied to the perfume solid as described above, the perfume solid is anionized and is concentrated on the region around the lower end portion of the capillary column 234, and the anionized perfume is moved by capillary pressure from the charging space 232 to the collection space 233 along the capillary column 234, which is electrified by the application of electric current, and is diffused in the collection space 233.

The anionized perfume diffused in the collection space 233 is moved to the perfume-containing space P of the perfume housing unit 110 by the perfume supply fan 140, which will be described later, and the perfume moved to the perfume-containing space P is introduced into the air duct 50 by the discharging force of the perfume supply fan 140, and is then supplied to the passenger compartment.

Since the perfume supplied to the passenger compartment is still anionized perfume and the passenger (human body) in the passenger compartment has electrical positive polarity (+) characteristics, there may be an advantage in that the perfume is more intensively diffused toward the passenger.

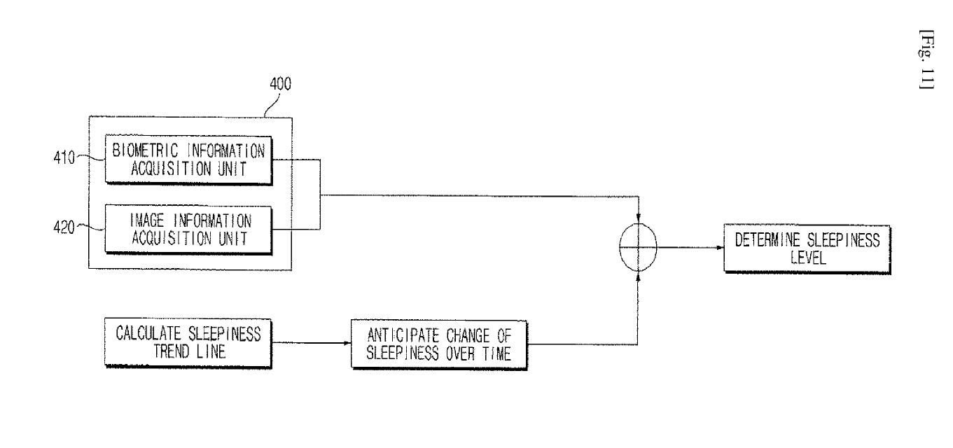

FIG. 10 is a plan view illustrating the state in which a case cover is removed from the constitution of a vehicular air cleaning device mounted inside the vehicle.

A second embodiment of the air freshener device for a passenger compartment of a vehicle, as illustrated in FIG. 10, may be disposed in air discharge ports 312 and 314 in a vehicular air cleaning device.

The vehicular air cleaning device 300, as illustrated in FIG. 10, may include a main case body 311, which is disposed at a region in the passenger compartment, such as, for example, a rear shelf behind the rear seats, in which there is no interference with the driver's view and the passenger's behavior, a case cover (not illustrated), which is coupled to the main case body 311 to cover the same so that the main case body 311 and the case cover define a predetermined space together thereinside, and a centrifugal fan 330, which is disposed in a predetermined space so as to suck air from the passenger compartment through an air suction port (not illustrated) formed in the upper portion of the air cleaning device and to discharge purified air into the passenger compartment through the air discharge ports 312 and 314.

In the vehicular air cleaning device 300, the main case body 311 and the case cover may be formed in a slim-type hexahedral shape, in which the height is smaller than the width and the anterior-posterior length, and the air discharge ports 312 and 314 may be formed in two opposing regions, for example, the left side surface and the right side surface, or the front surface and the rear surface.

The centrifugal fan 330 may be embodied as a sirocco fan, which generates air flow force by rotation so as to suck air from the passenger compartment through the air suction port formed in the top surface thereof and to discharge air laterally through the air discharge ports formed in the two regions.

An electrostatic filter (not illustrated) for filtering electrified dust particles may be disposed in the region adjacent to the air suction port, another electrostatic filter 326 may be disposed in the region adjacent to any one of the two air discharge ports, and a deodorization filter (not illustrated) for removing unpleasant smells may be disposed in the region adjacent to the other air discharge port.

Hereinafter, any one of the two air discharge ports of the air cleaning device 300 will be referred to as a first air discharge port 312, and the other air discharge port will be referred to as a second air discharge port 314. In addition, for clear explanation, the electrostatic filter disposed near the air suction port will be referred to as a first electrostatic filter, and the electrostatic filter disposed near the second air discharge port 314 will be referred to as a second electrostatic filter 326.

Although not illustrated, a first door for opening and closing the first air discharge port 312 may be provided between the first air discharge port 312 and the centrifugal fan 330, and a second door for opening and closing the second air discharge port 314 may be provided between the second air discharge port 314 and the centrifugal fan 330.

The second embodiment of the air freshener device for a passenger compartment of a vehicle may be constituted such that the above-described anion perfume module 101 in accordance with the second embodiment is of a built-in type, which is installed on the bottom surface of at least any one of the two air discharge ports 312 and 314. The anion perfume module provided in the air freshener device for a passenger compartment of a vehicle in accordance with the second embodiment will be denoted by reference numeral 105 in the following description.

It is essential to design an air cleaning device 300 having lower resistance to airflow through the air discharge ports, and thus it is preferred that the anion perfume module 105 be mounted to the air discharge ports 312 and 314 so as not to increase the resistance to airflow.

The anion perfume module 105 may be disposed in both the first air discharge port 312 and the second air discharge port 314 of the air cleaning device 300. Alternatively, the anion perfume module 105 may be disposed only in the second air discharge port 314. In this case, an ion generator 350, which generates one of cations and anions according to the user's selection, may be provided in the first air discharge port 312.

Hereinafter, the constitution in which the anion perfume module 105, which is the main component of the air freshener device for a passenger compartment of a vehicle, is mounted only to the second air discharge port 314 of the air cleaning device 300 will be explained.

The second embodiment of the air freshener device for a passenger compartment of a vehicle may further include a common power supply 350 for applying high voltage both to the anion perfume module 105 and to the ion generator 350. Because the power supply 350 of the vehicular air cleaning device 300, to which the existing ion generator 350 is mounted, may also be used as an electric current application unit for driving the anion perfume module 105, an increase in costs may be prevented.

Since the anion perfume module 105 provided in the second air discharge port 314 has the same constitution as the above-described anion perfume module 101 in accordance with the second embodiment, a detailed explanation of the constitution of the air freshener device for a passenger compartment of a vehicle in accordance with the second embodiment will be omitted.

The second embodiment of the vehicular air freshener device constituted as above may create various environments in the passenger compartment as follows.

In a first case, in which the user intends to drive only the ion generator 350, the first door is opened and the second door is closed. At this time, the air in the passenger compartment is sucked through the air suction port, and dust particles are first removed from the sucked air by the first electrostatic filter. As the air is discharged through the first air discharge port 312, odor components are removed by the deodorization filter 327, and an ion material generated from the ion generator 350 according to the user's selection is discharged to the passenger compartment with the purified air. Here, the process may be performed in the same way in the case of removing dust and smells from the passenger compartment without driving the ion generator 350. At this time, the supply of electric power from the power supply 350 to the ion generator 350 is cut off.

In a second case, in which the user intends to drive only the anion perfume module 105, the first door is closed, and the second door is opened. At this time, the air in the passenger compartment is sucked through the air suction port, and dust particles are removed from the sucked air by the first electrostatic filter. Only the perfume capsule selected by the user, among a plurality of perfume capsules 211, 213, 215 and 217, is operated to spray the user's desired perfume, and the air and the perfume are discharged together through the second air discharge port 314. At this time, the dust particles are completely removed from the discharged air by the second electrostatic filter 326. Here, in the case of removing only dust from the passenger compartment without driving the anion perfume module 105, the process may be performed in the same way. At this time, the supply of electric power from the power supply 350 to the anion perfume module 105 is cut off. Since unintentional perfume generation is extremely low so long as high-voltage current is not applied to the anion perfume module 105 of the air freshener device for a passenger compartment of a vehicle, the influence of perfume generation, undesired by the user, on the passenger compartment is very low even when air flows through the second air discharge port 314.

In a third case, in which the dust concentration and the smell concentration in the passenger compartment are both high and thus the user intends to promptly remove dust and smells at the same time, both the first door and the second door are opened. At this time, the air in the passenger compartment is sucked through the air suction port, and dust particles are removed from the sucked air by the first electrostatic filter. As a portion of the air is discharged through the first air discharge port 312, odor components are removed by the deodorization filter 327. As the remaining portion of the air is discharged through the second air discharge port 314, the remaining dust particles are removed by the second electrostatic filter 326. Of course, depending on the user's selection, the ion generator 350 and the anion perfume module 105 may be driven selectively or simultaneously.

Hereinafter, the method of effectively controlling the various embodiments of the air freshener device for a passenger compartment of a vehicle constituted as above will be described in detail.

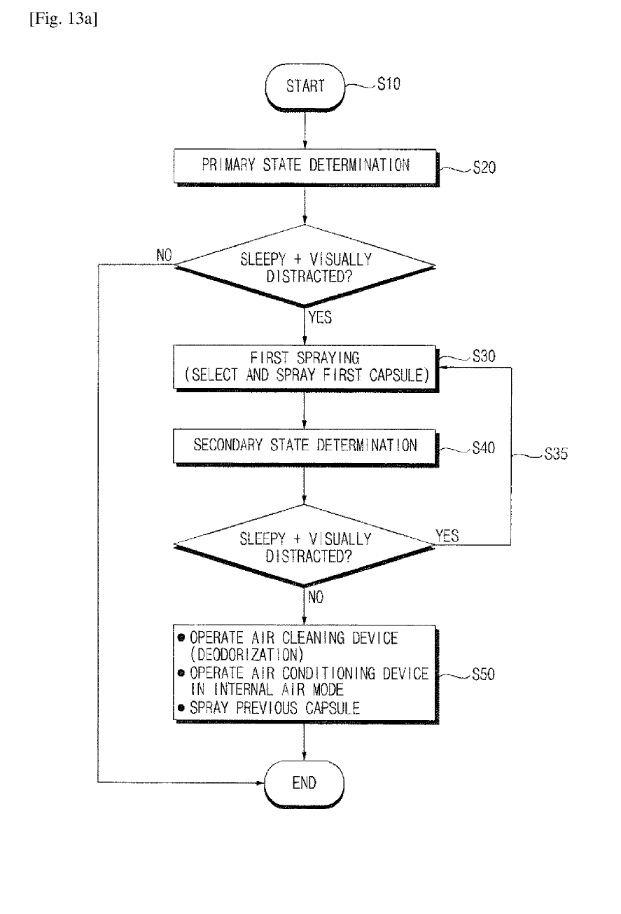

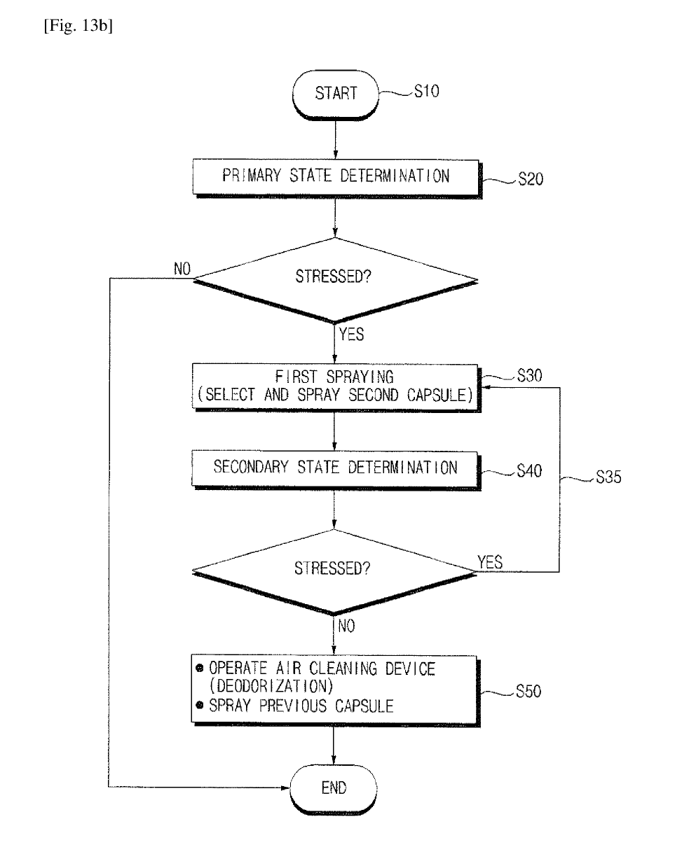

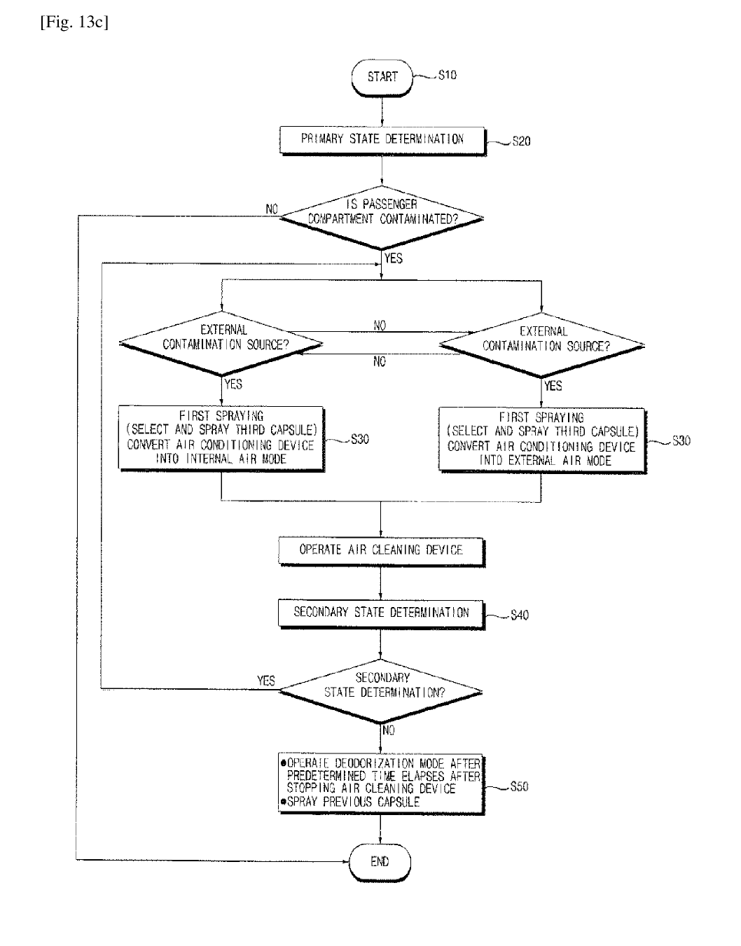

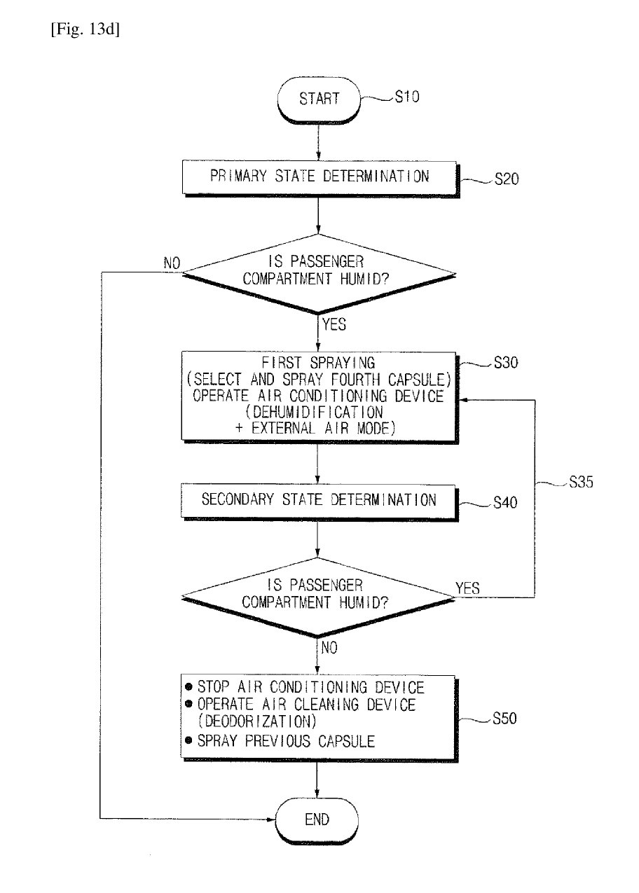

FIGS. 13a through 13d are control flowcharts illustrating a preferred embodiment of the method of controlling the air freshener device for a passenger compartment of a vehicle according to the present invention.

As described above, the main point of the constitution of the various embodiments of the air freshener device for a passenger compartment of a vehicle, which is intended to be controlled by the control method of the present invention, is that any one of a plurality of perfume capsules 211, 213, 215 and 217 can be selected so as to satisfy the user's taste.

The method of selecting any one of the plurality of perfume capsules 211, 213, 215 and 217, as described above, may include an active selection method, in which the user can achieve selection by directly manipulating the selection button switch, and a passive selection method, in which the selection can be achieved through automatic detection of the driver's physical state or of the air quality in the passenger compartment.

Recently, technical components for assisting safe driving have been added to vehicles, which are generically called an “Advanced Driver Assist System (ADAS)”, in order to automatically provide an optimum driving environment for a driver so that the driver's view can be secured all of the time while driving.

One of the technologies for detecting the driver's physical state, as disclosed in Korean Patent Registration No. 10-1298197, is a technology that is capable of determining that the driver is driving while drowsy when any one of the driver's head movement, the driver's body movement and the number of times of eye blinking, which are measured based on an image of the driver's face sensed by a camera or the like, deviates from a prescribed reference range.

In addition, one of the technologies for detecting the driver's emotional state, as disclosed in Korean Patent Registration No. 10-0851383, is a technology that is capable of detecting the driver's stress index through the driver's electrocardiogram, which is measured by various sensors provided in a steering wheel, a door armrest, a gearshift, etc. in order to obtain the driver's electrocardiogram signals.

The main purpose of the method of controlling the air freshener device for a passenger compartment of a vehicle according to the present invention is not to merely select any one of the plurality of perfume capsules 200 to diffuse the selected perfume, but, as described above, is to achieve the technical aspect of the ADAS through detection of the driver's emotional state and the air quality in the passenger compartment, thereby providing a more pleasant and safer driving environment for the driver.

In order to accomplish the above purpose, a preferred embodiment of the method of controlling the air freshener device for a passenger compartment of a vehicle according to the present invention includes a primary state determination step (S20), in which the driver's physical state or the state of air quality in the passenger compartment is determined, and a first spray step (S30), in which at least any one of the plurality of perfume capsules 211, 213, 215 and 217 is selected and the selected perfume is sprayed based on the determination result in the primary state determination step (S20).

Here, when the engine of the vehicle is started or the vehicle starts to move, the driver or the passenger may actively manipulate the selection button switch in order to operate his/her desired perfume capsule among the plurality of perfume capsules 200, or the perfume capsule 200 most recently selected before the current trip may be automatically selected and operated. Alternatively, according to the above-described technical characteristics of the ADAS, the perfume capsule 200 may be automatically selected and driven irrespective of the driver's or passenger's intention on the basis of the driver's physical state or the state of air quality in the passenger compartment at the moment when the vehicle starts to move.

Meanwhile, it is to be understood that so long as it can detect the driver's emotional state in the primary state determination step (S20) as described above, any detection means falls within the scope of the air freshener device for a passenger compartment of a vehicle according to the present invention.

The state determined in the primary state determination step (S20) and a secondary state determination step (S40), which will be described later, is the driver's physical state or the state of air quality in the passenger compartment. For convenience of explanation, in one embodiment of the present invention, the driver's physical state to be determined may be classified into a drowsy driving state, a visually distracted driving state, and a stressed state, and the state of air quality in the passenger compartment to be determined may be classified into a state in which the air in the passenger compartment is contaminated, that is, a contaminated state, and a state in which the humidity in the passenger compartment has a certain influence on the driver, that is, a humid state.

Here, the drowsy driving state will be referred to as a “first state”, the visually distracted driving state will be referred to as a “second state”, and the stressed state will be referred to as a “third state”. Of the states of air quality in the passenger compartment, the contaminated state will be referred to as a “first air quality state”, and the humid state will be referred to as a “second air quality state”. Particularly, the first air quality state when the air in the passenger compartment is contaminated by an external contamination source outside the passenger compartment will be referred to as an “externally contaminated state”, and the first air quality state when the air in the passenger compartment is contaminated by an internal contamination source inside the passenger compartment will be referred to as an “internally contaminated state”. The externally contaminated state and the internally contaminated state are distinguished from each other only by the source of contamination, and it should be understood that the both states indicate the state in which the air in the passenger compartment is contaminated.

Here, the above-described classification into five states is merely a specific example for helping understanding of the present invention and is not intended to limit the scope of the present invention.

In the preferred embodiment of the method of controlling the air freshener device for a passenger compartment of a vehicle according to the present invention, the above-described first through third states may be based on information gathered by an information acquisition unit 400 mounted inside the vehicle. The information acquisition unit 400 may be embodied as various information acquisition means, however, in the preferred embodiment of the present invention, the information acquisition unit 400 includes a biometric information acquisition unit 410, which performs a sensing operation via direct contact with the driver's body, and an image information acquisition unit 420, which performs a sensing operation by capturing an image of the driver.

The information acquired through the information acquisition unit 400 may be determined by a control unit (not illustrated).

Here, the biometric information acquisition unit 410 may refer to any composition for acquiring biometric information via direct contact with a specific body part of the driver, and the image information acquisition unit 420 may refer to any composition for gathering image data of the driver's appearance.

The biometric information acquisition unit 410 may be embodied as a wearable device, which has been commercialized recently, and the image information acquisition unit 420 may be embodied as a camera device, which is capable of capturing images of the driver's appearance, such as, for example, the face or eyes, and of analyzing the variation therein.

The biometric information acquisition unit 410 functions to acquire biometric information through a specific body part of the driver. According to one embodiment, the biometric information acquisition unit 410 may acquire biometric information by measuring bio-signals that are generated due to variation in the physiological potential of the human body. As an example, the biometric information acquisition unit 410 may include at least one of a pulse plethysmography (PPG) sensor, an electrocardiogram (ECG) sensor, a galvanic skin reflex (GSR) sensor, an electroencephalogram (EEG) sensor, an electromyogram (EMG) sensor, and an electrooculography (EOG) sensor. These sensors may measure bio-signals related to a pulse blood flow rate, an electrocardiogram, a galvanic skin reflex, a brainwave, an electromyogram, and an electrooculogram.

The image information acquisition unit 420 is a means that is capable of managing image frames of still images or video, which are acquired through the image sensor, such as the aforementioned camera, and functions to acquire images of the driver.

Preferably, the image information acquisition unit 420 may be directed toward the driver in order to acquire images of the driver, and may be mounted to an interior portion or an exterior portion of the vehicle.

In order to more clearly understand the preferred embodiment of the method of controlling the air freshener device for a passenger compartment of a vehicle according to the present invention, the classification of the driver's physical state, which is acquired through the above-described biometric information acquisition unit 410 and the image information acquisition unit 420, will now be explained in more detail.

For reference, the degree of sleepiness, as shown in Table 1 below, may be classified into 7 levels in accordance with the HFC and the SSS, and may be classified into 9 levels in accordance with the KSS.

TABLE 1

| | | HFC | KSS | SSS |
|---|---|---|---|---|
| Level | | (Human Fatigue-Scale) | (Karolinska Sleepiness Scale) | (Stanford Sleepiness Scale) |
| Activated | 1 | Wide awake, active | Extremely alert | Feeling active, vital, |
| | 2 | attention | Very alert | alert, wide awake |
| | 3 | Fresh and concentrate but | Alert | Functioning at a high |
| | | focused attention | | level but not at peak, |
| | | | | able to concentrate |
| | 4 | Neither activated nor | Rather alert | Relaxed, awake but not |
| | 5 | tired, reactivity without | Neither alert nor sleepy | fully alert, responsive |
| | | notable tendency | | |
| Tired | 6 | First sign from tiredness | Some signs of sleepiness | A little foggy, let down |
| | | but effortless awake | | |
| | 7 | Tired but mainly on the | Sleepy, no effort to stay | Foggy, beginning to lose |
| | | actions aligned | awake | track, difficulty staying |
| | | | | awake |
| | 8 | Struggle against the | Sleepy, no effort to stay | Sleepy, prefer to lie |
| | | sleep, actions falls heavy | awake | down, woozy |
| | | but widely receptable | | |
| | 9 | Absently, impassive, long | Very sleepy, great effort to | Almost in reverie, cannot |
| | | chapter without activity, | keep awake, fighting sleep | stay awake, sleep onset |
| | | Second sleep probable or | | appears imminent |
| | | appears | | |

As an example, when the control unit determines whether the driver is driving while drowsy using the image information, the determination may be carried out on the basis of any one or a combination of the driver's facial expression, eye opening time period, eye blinking, and face direction.

That is, the control unit may determine whether the driver is driving while drowsy on the basis of the proportion of time that the driver's eyelids are open or closed to a prescribed time.

Here, the time that the driver's eyelids are closed may be the time that the eyelids are closed, determined based on a threshold of approximately 70 percent or 80 percent of the difference between the maximum size and the minimum size of the driver's eye.

As another example, the control unit may determine whether the driver is driving while drowsy on the basis of eye blinking.

In particular, when it is determined that the driver's eyes blink, it may be determined whether the driver is driving while drowsy on the basis of an average squared value of eyelid closure rate, which is calculated by dividing the total squared value of eyelid closure rate by the number of times of eye blinking, or on the basis of a simple average value of eyelid closure rate, which is calculated by dividing the total value of the eyelid closure rate by the number of times of eye blinking.

At this time, it may be determined whether the driver is driving while drowsy on the basis of the average squared value or the simple average value of the eyelid closure rate using the larger one of the left eye and the right eye.

As yet another example, when the control unit determines that the driver's eyes blink, the control unit may determine whether the driver is driving while drowsy on the basis of the number of blinks when the time taken for a single eye blink is equal to or longer than a predetermined time period (approximately 0.5 seconds or 1 second), in consideration that eye blinking takes little time.

As a further example, when the control unit determines that the driver's eyes blink, the control unit may determine whether the driver is driving while drowsy on the basis of whether the time taken for a single eye blink is equal to or longer than the aforementioned predetermined time.

As a further example, when the control unit determines that the driver's eyes blink, the control unit may determine whether the driver is driving while drowsy on the basis of a value that is calculated by dividing the total number of blinks when the time taken for a single eye blink is equal to or longer than a predetermined time period (approximately 2 seconds) by the number of event groups in each of which such slow eye blinks occur consecutively.

For instance, assuming that it is determined that the driver's eyes blink and the case in which the time taken for a single eye blink is equal to or longer than a predetermined time period (approximately 2 seconds) is represented by “1”, the calculation in the case of 0000110000111100001110000 is as follows: (2+4+3)/3=3, and it may be determined whether the driver is driving while drowsy on the basis of the calculated value “3”. That is, the control unit may evaluate the level of sleepiness on the basis of the magnitude of the above calculated value, and as the above calculated value is larger, it may be estimated that the evaluated level of sleepiness of the driver is higher.

As a further example, the control unit may determine whether the driver is driving while drowsy on the basis of the eye blink frequency. In particular, when it is determined that the driver's eyes blink, the control unit may determine whether the driver is driving while drowsy on the basis of the number n of blinks when the time taken for a single eye blink is equal to or longer than a predetermined time period (approximately 2 seconds).

As a further example, the control unit may determine whether the driver is driving while drowsy on the basis of the speed of eye blinking.

In particular, the speed at which the eyes are closed is measured, and the control unit may determine whether the driver is driving while drowsy on the basis of an average value AECS that is calculated by dividing the total measured speed by the number of eye blinks. Unlike this, when it is determined that the driver's eyes blink, the control unit may determine whether the driver is driving while drowsy on the basis of a value APCV that is calculated by dividing the largest value of the eyelid closure rates by the maximum value of the speed at which the eyelid is closed.

At this time, the value APCV may be the most recent value, or may be the average value of several calculations.

As a further example, the control unit may determine whether the driver is driving while drowsy on the basis of whether the pupil of the eye is contracted (or the iris of the eye is relaxed).

As a further example, the control unit may determine whether the driver is nodding on the basis of whether the driver's face direction is changed vertically over time, and may determine whether the driver is driving while drowsy on the basis of the above determination result.

As a further example, the control unit may determine whether the driver is yawning on the basis of the driver's facial expression, and may determine whether the driver is driving while drowsy on the basis of the above determination result.

As described above, the control unit may determine whether the driver is driving while drowsy on the basis of any one of the driver's facial expression, eye opening time period, eye blinking, and face direction. However, in order to accurately determine the level to which the degree of sleepiness of the driver corresponds, it is preferable to determine the drowsy driving state on the basis of a combination of the above information related to the driver's physical state.

When the control unit determines whether the driver is driving while drowsy or the level to which the degree of sleepiness of the driver corresponds on the basis of a combination of a plurality of pieces of information related to the driver's physical state (for example, driver's facial expression, eye opening time period, eye blinking, and face direction), each of the plurality of pieces of information related to the driver's physical state may be given a weighted value.

Here, when the control unit determines whether the driver is driving while drowsy or the level to which the degree of sleepiness of the driver corresponds on the basis of a plurality of pieces of information, such as, for example, the driver's facial expression, eye opening time period, eye blinking, and face direction, the weighted value for each piece of information may be preferably a weighted value that is set through learning based on a massive database with respect to the above information in order to improve the determination accuracy.

At this time, the control unit may generate a learning model on the basis of a database regarding image information and biometric information of the driver or ordinary people including the driver, and may set the dangerous driving state or the danger level on the basis of the learning model generated as above.

On the other hand, as described above, the control unit may determine whether the driver is driving while drowsy on the basis of the biometric information acquired through the biometric information acquisition unit 410.

The control unit may determine whether the driver is driving while drowsy on the basis of bio-signals with respect to the electromyogram measured by the EMG sensor or galvanic skin reflex signals measured by the GSR sensor.

When the control unit determines whether the driver is driving while drowsy or the level to which the degree of sleepiness of the driver corresponds on the basis of the biometric information, each of the above-described pieces of biometric information may be given a weighted value.

Also when the control unit determines whether the driver is driving while drowsy or the level to which the degree of sleepiness of the driver corresponds on the basis of a plurality of pieces of information, such as the values measured by the EMG sensor, the GSR sensor, etc., the weighted value for each piece of information (for example, each value measured by the EMG sensor, the GSR sensor, etc.) may be preferably a weighted value that is set through learning based on a massive database with respect to the above information in order to improve the determination accuracy.

At this time, the control unit may generate a learning model on the basis of a database regarding image information and biometric information of the driver or ordinary people including the driver, and may set the dangerous driving state or the danger level on the basis of the learning model generated as above.

Meanwhile, when the control unit determines whether the driver is driving while drowsy on the basis of only the image information or on the basis of only the biometric information, the range of levels for evaluating the drowsy driving state may be limited, and it may be impossible to accurately determine the level to which the degree of sleepiness of the driver corresponds.

Therefore, in order to solve this problem, it is preferable for the control unit to determine whether the driver is driving while drowsy on the basis of the biometric information as well as the image information.

When the control unit determines whether the driver is driving while drowsy on the basis of the image information and the biometric information, it is preferable for each of the image information and the biometric information to be given a weighted value, in order to determine the level to which the degree of sleepiness of the driver corresponds.

Here, when the control unit evaluates the drowsy driving state, the relationship between the weighted value for the image information and the weighted value for the biometric information is not specifically limited, and may vary according to the environment. However, it is preferable that the weighted value for the image information be larger than the weighted value for the biometric information.

The relationship between the weighted value for the image information and the weighted value for the biometric information may differ for each of the drowsy driving state, the visually distracted driving state, and the stressed state. Accordingly, it is preferable to apply different weighted values to the image information and the biometric information according to the respective dangerous driving states, in order to determine which dangerous driving state it is or the danger level to which the specific dangerous driving state corresponds.

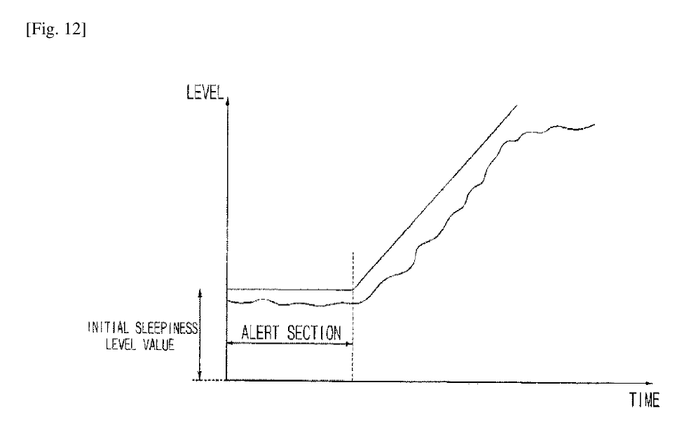

When the control unit determines whether the driver is driving while drowsy or the level to which the degree of sleepiness of the driver corresponds, as described above, it is preferable to consider all of the image information and the biometric information. It may be more preferable to additionally consider a sleepiness trend line (refer to FIG. 12), which is calculated using at least one of information about sleep, for example, lack of sleep, of the driver and information about the biorhythm of the driver before entering the vehicle.

FIG. 11 is a block diagram illustrating the process of determining the drowsy driving state or the sleepiness level according to one embodiment disclosed in the specification, and FIG. 12 is a view illustrating the sleepiness trend line of the driver according to one embodiment disclosed in the specification.

As illustrated in FIG. 12, the control unit may anticipate a change in the level to which the degree of sleepiness of the driver corresponds over time.

The sleepiness trend line is a graph showing the sleepiness level over time on the basis of whether the driver is on board or whether the driver is driving. As illustrated in FIG. 12, the sleepiness trend line may include the initial sleepiness level of the driver right after entry of the driver or right after the driver starts to drive, a time period during which the initial sleepiness level is maintained before the sleepiness level is changed, and the rate of change of the sleepiness level over time.

The control unit may anticipate the sleepiness level of the driver using the sleepiness trend line calculated as above.

In other words, using the driver's biometric information, acquired before entering the vehicle or before starting to drive, the control unit may analyze the information about the driver's sleep, and may calculate the sleepiness trend line on the basis of the analyzed information about the driver's sleep, thereby anticipating the sleepiness level over time after entry of the driver or after the driver starts to drive.

As such, a preferred embodiment of the method of controlling the air freshener device for a passenger compartment of a vehicle according to the present invention may anticipate the driver's sleepiness level, and may alert the driver to the dangers of drowsy driving by spraying the perfume selected by the driver before the driver becomes unable to drive normally due to extreme sleepiness, thereby preventing traffic accidents which may be caused by drowsy driving.

When the control unit determines the driver's sleepiness level, the control unit may combine a first sleepiness level, which is calculated based on the biometric information, and a second sleepiness level, which is calculated based on the sleepiness trend line, thereby accurately calculating the driver's sleepiness level.

By applying a predetermined weighted value to each of the first sleepiness level and the second sleepiness level, the driver's sleepiness level may be finally calculated.

At this time, the weighted value applied to each of the first sleepiness level and the second sleepiness level may be a value that is previously set via driver input, or may vary adaptively to the driver confirmation input with respect to the finally determined driver's sleepiness level. That is, if the finally determined driver's sleepiness level is “3” but the driver confirmation input value, which is input through a driver input unit, is “2”, not “3”, the weighted value may be changed so that the finally determined driver's sleepiness level becomes “2”.

The second state, i.e. the visually distracted driving state, of the driver's physical state may also be minutely determined through the image information acquisition unit 420 using the following logic.

That is, it is possible for the control unit to determine the visually distracted driving state, among the dangerous driving states, on the basis of at least one of the image information and the biometric information.

When the control unit determines the visually distracted driving state using the image information, the determination may be achieved on the basis of any one or a combination of the driver's face direction and the driver's gaze direction.

As an example, the control unit may calculate the driver's face direction and the driver's gaze direction on the basis of the image information acquired through one or more image acquisition devices, and may determine the visually distracted driving state on the basis of the calculated driver's face direction and gaze direction.

When the control unit determines the visually distracted driving state, the level of visual distraction may be decided in consideration of the driver's gaze direction, the degree of change in gaze direction, the time period during which the driver gazes in one specific direction, etc.

On the other hand, when the control unit determines the visually distracted driving state on the basis of any one or a combination of the driver's face direction and the driver's gaze direction, the control unit may select at least one of a plurality of image acquisition devices, which corresponds to the eye gaze coordinates of the driver's gaze position.

To this end, a plurality of image acquisition devices, which are configured to acquire images of the region of interest (ROI) according to the eye gaze coordinates, may be mounted so as to be directed toward a plurality of regions inside or outside the vehicle in order to acquire image information of the plurality of regions.

The control unit may select at least one of the plurality of image acquisition devices, which is directed toward the ROI of the driver.

Accordingly, the control unit may recognize at least one object from the image information that is acquired through the selected image acquisition device, and may perform the control command corresponding to the recognized object.

On the other hand, the control unit may determine the visually distracted driving state on the basis of biometric information, which is acquired through the biometric information acquisition unit 410, including the EOG sensor, the EMG sensor, etc., as well as the image information. When the control unit determines whether the driver is driving while drowsy on the basis of the image information and the biometric information, it is preferable to apply a weighted value to each of the image information and the biometric information so as to determine the level to which the degree of sleepiness of the driver corresponds.

Here, when the control unit evaluates the drowsy driving state, the relationship between the weighted value for the image information and the weighted value for the biometric information is not specifically limited, and may vary according to the environment. However, it is preferable that the weighted value for the image information be larger than the weighted value for the biometric information.

At this time, the relationship between the weighted value for the image information and the weighted value for the biometric information may be different from the relationship between the weighted values in the drowsy driving state or in the stressed state.

In addition, the third state, i.e. the stressed state, of the driver's physical state may also be minutely determined through the image information acquisition unit 420 using the following logic.

That is, it is possible for the control unit to determine the stressed state, among the dangerous driving states, on the basis of at least one of the image information and the biometric information.

When the control unit determines the driver's stressed state using the image information, the determination may be achieved on the basis of the driver's facial expression.

As an example, when it is determined that the driver's facial expression looks angry, the driver may be determined to be in a stressed state.

The driver's stress level may be decided based on the driver's facial expression. At this time, a massive database, in which information about a correlation between stress levels and the driver's facial expression is stored, may be used.

In addition, the control unit may determine the driver's stressed state on the basis of the biometric information acquired through the biometric information acquisition unit 410.

As an example, the control unit may determine the driver's stress level based on heart rate and/or heart rate variability, which are measured through the PPG sensor. At this time, a filter may be used, or noise removal may be performed in order to improve the accuracy of stress level measurement.

When the control unit determines the driver's stressed state and the driver's stress level on the basis of the plurality of pieces of biometric information, a weighted vale may be applied to each of the plurality of pieces of biometric information. The weighted value for each piece of information may be preferably a weighted value that is set through learning based on a massive database in order to improve the determination accuracy with respect to the driver's stressed state and the stress level.

At this time, the control unit may generate a learning model on the basis of a database regarding image information and biometric information of the driver or ordinary people including the driver, and may set the dangerous driving state or the danger level on the basis of the learning model generated as above.

Meanwhile, when the control unit determines the driver's stressed state on the basis of only the image information or on the basis of only the biometric information, the range of levels for evaluating the stressed state may be limited, and it may be impossible to accurately determine the level to which the degree of stress of the driver corresponds.

Therefore, in order to solve this problem, it is preferable for the control unit to determine the driver's stressed state on the basis of the biometric information as well as the image information.

When the control unit determines the driver's stressed state on the basis of the image information and the biometric information, it is preferable that each of the image information and the biometric information be given a weighted value, in order to determine the level to which the degree of stress of the driver corresponds.

Here, when the control unit evaluates the drowsy driving state, the relationship between the weighted value for the image information and the weighted value for the biometric information is not specifically limited, and may vary according to the environment. However, it is preferable that the weighted value for the biometric information be larger than the weighted value for the image information.

The relationship between the weighted value for the image information and the weighted value for the biometric information may be different from the relationship between the weighted values in the drowsy driving state or in the visually distracted driving state.

When the control unit determines the driver's stressed state or the driver's stress level, as described above, it is preferable to consider all of the image information and the biometric information. It may be more preferable to additionally consider a sleepiness trend line (refer to FIG. 12), which is calculated using at least one of information about sleep, for example, lack of sleep, of the driver and information about the biorhythm of the driver before entering the vehicle.

Because the driver's stressed state and the stress level may be affected by the driver's sleep state, for example, lack of sleep, the above-described sleepiness trend line (refer to FIG. 12) may be used.

That is, when the control unit determines the driver's stress level, the control unit may combine a first stress level, which is calculated based on the image information and the biometric information, and a second stress level, which corresponds to the sleepiness level calculated based on the sleepiness trend line, thereby accurately calculating the driver's stress level.

By applying a predetermined weighted value to each of the first stress level and the second stress level, the driver's stress level may be finally calculated.

At this time, the weighted value applied to each of the first stress level and the second stress level may be a value that is previously set via driver input, or may vary adaptively to the driver confirmation input with respect to the finally determined driver's stress level.

As described above, the dangerous driving states may be detected based on the evaluation levels, acquired and determined through the biometric information acquisition unit 410 or the image information acquisition unit 420.

Here, the dangerous driving states may include the drowsy driving state, the visually distracted driving state, and the stressed state, described above.

In addition, with respect to the respective dangerous driving states, the control unit may generate danger level information, including a drowsy driving level, which indicates the degree of drowsy driving, a visually distracted driving level, which indicates the degree of visually distracted driving, and a stress level, which indicates the degree of stress.

At this time, when the control unit generates the danger level information on the basis of the image information and the biometric information, it is preferable to apply a weighted value to each of the image information and the biometric information. The weighted values may differ for each of the drowsy driving state, the visually distracted driving state, and the stressed state.

As described above, when the control unit generates the danger level information, in the case of the drowsy driving state and the visually distracted driving state, the weighted value applied to the image information is larger than the weighted value applied to the biometric information, and in the case of the stressed state, the weighted value applied to the biometric information is larger than the weighted value applied to the image information.

So far, the processes of determining the first through third states, which indicate the driver's physical state, using the biometric information acquisition unit 410 and the image information acquisition unit 420, which constitute the information acquisition unit 400, have been described.

However, in a preferred embodiment of the method of controlling the air freshener device for a passenger compartment of a vehicle according to the present invention, the information acquisition unit 400 is not limited to the biometric information acquisition unit 410 and the image information acquisition unit 420.

The information acquisition unit 400 may further include an air quality sensor (not illustrated) for sensing the air quality in the passenger compartment.

The air quality sensor may be embodied as complex sensor modules, which are removably mounted in a plurality of regions inside and outside the passenger compartment, in order to individually sense the degree of air contamination around the plurality of mounting regions.

Preferably, at least one complex sensor module may be provided in an engine compartment located in the front portion of the vehicle body, in which an engine is mounted, so as to sense the contamination of external air. In the case of a vehicle having no engine compartment provided in the front portion of the body thereof, the complex sensor module may be provided in any region of the vehicle body so long as it is located in a position through which external air passes before entering the passenger compartment.

The complex sensor module may include a sensor case having an air flow space, through which air flows in and out in one direction, an air flow fan, which is provided inside the sensor case and is configured to forcibly make air flow, and a group of sensors, which are arranged in series in the air flow direction inside the sensor case and are configured to sense respectively different features contained in the air.

With the air quality sensor embodied as the complex sensor module, as described above, the state of air quality in the passenger compartment may be easily classified into the contaminated state (first air quality state) and the humid state (second air quality state). In addition, it may be immediately determined whether the first air quality state is caused by an external contamination source outside the passenger compartment (externally contaminated state) or by an internal contamination source inside the passenger compartment (internally contaminated state).

The first spray step (S30) and the second spray step (S35) are steps for selecting a perfume capsule 200, which promotes safe driving or improves the air quality in the passenger compartment by resolving problems of the state determined in the primary state determination step (S20) and the secondary state determination step (S40), and for spraying the selected perfume. Here, a single perfume capsule 200 may be selected, or two or more perfume capsules 200 may be selected.

In particular, the secondary state determination step (S40) is a step for re-determining whether the state determined in the primary state determination step (S20) still exists or whether the problem has been resolved through the selection and spray of the perfume capsule 200 into the passenger compartment in the first spray step (S30).

When it is determined that the problem has been resolved in the secondary state determination step (S40), the perfume capsule 200, which was selected before the primary state determination step (S20), is sprayed again (refer to S50). When it is determined that the state is still maintained in the secondary state determination step (S40), the perfume capsule 200, which was selected in the first spray step (S30), is continuously sprayed.

In one embodiment, the method of controlling the air freshener device for a passenger compartment of a vehicle in accordance with the present invention through the above-described control process is completely terminated when driving is finished. As described above, the perfume capsule 200, which was in the state of having been selected upon the completion of driving, is memorized in a storage unit (not illustrated) of the vehicle, and when a start signal is input in a start step (S10), the information memorized in the storage unit may serve as a reference for selecting the perfume capsule 200 before the primary state determination step (S20) (refer to S50).

One embodiment of the method of controlling the air freshener device for a passenger compartment of a vehicle in accordance with the present invention, which has the above-described control process, will now be explained in more detail with reference to the accompanying drawings (particularly FIGS. 13a through 13d).

A plurality of perfume capsules 200 may include a first capsule, which has a certain stimulating ingredient for awakening the driver in the drowsy driving state (first state) or the visually distracted driving state (second state), a second capsule, which has a certain stress-relieving ingredient for relieving the driver's stressed state (third state), a third capsule, which has a certain medicinal ingredient acting as a driver's health supplement and is selected when the state of air quality in the passenger compartment is affected by an external contamination source outside the passenger compartment (externally contaminated state) or by an internal contamination source inside the passenger compartment (internally contaminated state) (i.e. first air quality state), and a fourth capsule, which has a certain purifying ingredient for improving the air quality in the passenger compartment when the state of air quality in the passenger compartment is the humid state (i.e. second air quality state).

The control process according to the method of controlling the air freshener device for a passenger compartment of a vehicle in accordance with the present invention is started (S10) when the vehicle starts to run.

The first through fourth capsules may be individually sprayed so as to emit a single scent having a specific function, or two or more capsules may be sprayed together so as to emit a mixed scent capable of performing multiple functions.

More particularly, as illustrated in FIG. 13a, when it is determined that the driver is in the first state or the second state in the primary state determination step (S20) or the secondary state determination step (S40), the first capsule is selected and sprayed in the first spray step (S30) or the second spray step (S35), thereby stimulating the driver to stay alert or overcome the extremely drowsy driving state or the visually distracted driving state, which may threaten safe driving.

As another example, as illustrated in FIG. 13b, when it is determined that the driver is in the third state in the primary state determination step (S20) or the secondary state determination step (S40), the second capsule is selected and sprayed in the first spray step (S30) or the second spray step (S35), thereby helping the driver to overcome the stressed state.

However, the driver's physical state, determined in the above-described control process, is not limited to a single pattern. The driver's physical state may be determined to have a complicated pattern, for example, a combination of the first through third states.

In this case, although not illustrated, the first capsule and the second capsule may be simultaneously selected and sprayed in the first spray step (S30) or the second spray step (S35), thereby changing the driver's physical state so as to drive safely.

As yet another example, as illustrated in FIG. 13c, when it is determined that the state of air quality in the passenger compartment is the first air quality state in the primary state determination step (S20) or the secondary state determination step (S40), the third capsule is selected and sprayed in the first spray step (S30) or the second spray step (S35), thereby resolving the problem of air contamination in the passenger compartment.

Further, as illustrated in FIG. 13d, when it is determined that the state of air quality in the passenger compartment is the second air quality state, i.e. a humid state that gives the driver an unpleasant feeling, in the primary state determination step (S20) or the secondary state determination step (S40), the fourth capsule is selected and sprayed in the first spray step (S30) or the second spray step (S35), thereby lowering the driver's discomfort index.

Here, although not illustrated, the state of air quality in the passenger compartment, which is determined in the primary state determination step (S20) and the secondary state determination step (S40), is not limited to the first air quality state and the second air quality state, and may at times be determined to be a complex state. Therefore, similar to the case in which the driver's physical state is determined to be a complex state, the third capsule and the fourth capsule may be simultaneously selected and sprayed in the first spray step (S30) and the second spray step (S35).

Meanwhile, not although all vehicle models are the same, they may include an air conditioning device for supplying conditioned air to the passenger compartment, and an air cleaning device 300 for purifying the air in the passenger compartment.

In addition to the selective spray of the plurality of perfume capsules, a preferred embodiment of the method of controlling the air freshener device for a passenger compartment of a vehicle in accordance with the present invention may adequately control the operation of the air conditioning device and the air cleaning device 300, thereby improving the operational effects thereof.

For example, as illustrated in FIGS. 13a through 13d, after the second spray step (S35) is performed, when the driver's physical state and the state of air quality in the passenger compartment are changed into the states desired by the driver (that is, the driver's physical state is changed so that the driver drives safely and the problem with the state of air quality in the passenger compartment, i.e. contamination and high humidity, is resolved), the air cleaning device 300 may be driven to perform a deodorization mode (refer to S50) in order to remove the selectively emitted scent in the first spray step (S30) or the second spray step (S35).

Particularly, as illustrated in FIG. 13c, when it is determined that the state of air quality in the passenger compartment is the first air quality state in the primary state determination step (S20) and the secondary state determination step (S40), the air cleaning device 300 may be immediately operated in the contamination removal mode so as to promptly solve the problem of air contamination in the passenger compartment.

On the other hand, the air conditioning device may be operated in the external air mode for allowing external air to flow into the passenger compartment, or may be operated in the internal air mode for circulating internal air in the passenger compartment (refer to S50).

Particularly, as illustrated in FIGS. 13a and 13b, the air conditioning device may be operated in the internal air mode, simultaneously with or after the deodorization mode of the air cleaning device 300 for removing the existing scent, so as to block the inflow of external air (refer to S50).

In addition, as illustrated in FIG. 13c, when it is determined that the state of air quality in the passenger compartment is the externally contaminated state in the primary state determination step (S20) or the secondary state determination step (S40), the operating mode of the air conditioning device may be converted into the internal air mode in order to prevent contaminated external air from flowing into the passenger compartment. When the state of air quality in the passenger compartment is the internally contaminated state, the operating mode of the air conditioning device may be converted into the external air mode in order to purify the contaminated internal air in the passenger compartment using uncontaminated external air (refer to S50).

In addition, as illustrated in FIG. 13d, when it is determined that the state of air quality in the passenger compartment is the humid state in the primary state determination step (S20) or the secondary state determination step (S40), the air conditioning device may be operated in the dehumidification mode and the external air mode, and when it is determined that the state of air quality is not the humid state any longer in the secondary state determination step (S40), the operation of the air conditioning device may be stopped, so that the emitted scent can give the driver its own functional effect (refer to S50).

The preferred embodiment and other embodiments of the method of controlling an air freshener device for a passenger compartment of a vehicle according to the present invention has been explained in detail with reference to the accompanying drawings. However, the embodiments of the present invention are not limited thereto, and it will be apparent that various modifications and other embodiments are possible within the scope of the invention. Accordingly, the substantial scope of the invention shall be determined only by the appended claims and their equivalents.

1. A method of controlling an air freshener device for a passenger compartment of a vehicle, the air freshener device comprising (i) a perfume housing unit that is arranged to communicate with an air duct of a vehicular air conditioning device and that defines a perfume-containing space configured to contain a perfume therein, (ii) a perfume tray rotatably provided in the perfume housing unit, (iii) a plurality of perfume capsules disposed at the perfume tray, and (iv) an electric current application unit configured to apply electric current to any one of the perfume capsules, the method comprising:
first determining a physical state of a driver or a state of air quality in the passenger compartment;
first spraying, into the passenger compartment, at least one first perfume capsule among the plurality of perfume capsules selected based on a determination result of the physical state of the driver or the state of air quality in the passenger compartment in the first determining, by an operation of stopping the perfume tray and electrically connecting, by the electric current application unit, the at least one first perfume capsule;
second determining the physical state of the driver or the state of air quality in the passenger compartment after the first spraying or during the first spraying; and
based on determining that the physical state of the driver or the state of air quality in the passenger compartment has changed in the second determining, second spraying at least one second perfume capsule that is newly selected among the plurality of perfume capsules, including the at least one first perfume capsule which is currently being sprayed.

2. The method according to claim 1, wherein the physical state of the driver, to be determined in the first determining and the second determining, is classified into a drowsy driving state (hereinafter, referred to as a “first state”), a visually distracted driving state (hereinafter, referred to as a “second state”), and a stressed state (hereinafter, referred to as a “third state”).

3. The method according to claim 2, wherein the first determining and the second determining include determining the physical state of the driver based on information about the driver, acquired by sensing the driver using a biometric information acquisition unit mounted to the vehicle.

4. The method according to claim 2, wherein the plurality of perfume capsules includes:
a first capsule having a predetermined stimulating ingredient so as to help the driver overcome the first state or the second state; and
a second capsule having a predetermined stress-relieving ingredient so as to help the driver overcome the third state.

5. The method according to claim 4, wherein, upon determining that the physical state of the driver is the first state or the second state in the first determining or the second determining, the first spraying and the second spraying include selecting and spraying the first capsule.

6. The method according to claim 4, wherein, upon determining that the physical state of the driver is the third state in the first determining or the second determining, the first spraying and the second spraying include selecting and spraying the second capsule.

7. The method according to claim 4, wherein, upon determining that the physical state of the driver is a combination of the first state and the third state or a combination of the second state and the third state in the first determining or the second determining, the first spraying and the second spraying include selecting and spraying the first capsule and the second capsule at the same time.

8. The method according to claim 1, wherein the state of air quality in the passenger compartment, to be determined in the first determining and the second determining, is classified into a contaminated state (hereinafter, referred to as a “first air quality state”), and a humid state (hereinafter, referred to as a “second air quality state”).

9. The method according to claim 8, wherein the first determining and the second determining include determining the state of air quality in the passenger compartment based on a sensing value from an air quality sensor mounted to an interior portion and an exterior portion of the vehicle.

10. The method according to claim 9, wherein the first air quality state is classified into a state in which a contamination source is outside the passenger compartment (hereinafter, referred to as an “externally contaminated state”), and a state in which the contamination source is inside the passenger compartment (hereinafter, referred to as an “internally contaminated state”).

11. The method according to claim 10, wherein the plurality of perfume capsules includes:
a third capsule having a predetermined medicinal ingredient serving as a health supplement for the driver; and
a fourth capsule having a predetermined purifying ingredient for improving the state of air quality in the passenger compartment.

12. The method according to claim 11, wherein, upon determining that the state of air quality in the passenger compartment is the first air quality state in the first determining or the second determining, the first spraying and the second spraying include selecting and spraying the third capsule.

13. The method according to claim 11, wherein, upon determining that the state of air quality in the passenger compartment is the second air quality state in the first determining or the second determining, the first spraying and the second spraying include selecting and spraying the fourth capsule.

14. The method according to claim 11, wherein, upon determining that the state of air quality in the passenger compartment is a combination of the first air quality state and the second air quality state in the first determining or the second determining, the first spraying and the second spraying include selecting and spraying the third capsule and the fourth capsule at the same time.

15. The method according to claim 5, further comprising:
operating an air conditioning device, provided in the vehicle, in an external air mode for allowing inflow of external air after determining that the physical state of the driver is the first state in the first determining until determining that the physical state of the driver is not the first state any longer in the second determining.

16. The method according to claim 12, further comprising:
operating an air cleaning device, provided in the vehicle, in a contamination removal mode for purifying contaminated air in the passenger compartment.

17. The method according to claim 13, further comprising:
operating an air conditioning device, provided in the vehicle, in an external air mode for allowing an inflow of external air and in a dehumidification mode for dehumidifying air in the passenger compartment after determining that the state of air quality in the passenger compartment is the second air quality state in the first determining until determining that the state of air quality in the passenger compartment is not the second air quality state any longer in the second determining.

18. The method according to any one of claims 2 and 8, further comprising:
upon determining that the physical state of the driver is not any one of the first through third states or that the state of air quality in the passenger compartment is not any one of the first and second air quality states in the second determining,
operating an air cleaning device, provided in the vehicle, in a deodorization mode for removing a scent of the at least one first perfume capsule sprayed into the passenger compartment; and
operating an air conditioning device, provided in the vehicle, in an internal air mode for circulating internal air in the passenger compartment.

19. The method according to claim 1, wherein the first spraying and the second spraying include selecting at least any one of the plurality of perfume capsules through insertion of injection needles into the perfume capsules, the perfume capsules being rotated by the perfume tray, and application of electric current to the injection needles.

20. The method according to claim 1, wherein the first spraying and the second spraying include selecting at least any one of the plurality of perfume capsules through application of electric current to at least any one of injection needles, the injection needles being already inserted into the plurality of perfume capsules disposed on a fixed perfume tray.
